(19) United States
(12) Patent Application Publication
(10) Pub. No.: US 2009/0265786 A1
(43) Pub. Date: Oct. 22, 2009

(54) AUTOMATIC BOTNET SPAM SIGNATURE GENERATION

(75) Inventors: Yinglian Xie, Cupertino, CA (US); Fang Yu, Sunnyvale, CA (US); Kannan Achan, Mountain View, CA (US); Rina Panigrahy, Sunnyvale, CA (US); Ivan Osipkov, Bothell, WA (US); Geoffrey J. Hulten, Lynnwood, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/104,441

(22) Filed: Apr. 17, 2008

(51) Int. Cl. G06F 21/00

(52) U.S. Cl. 726/24

(57) ABSTRACT

A framework may be used for generating URL signatures to identify botnet spam and membership. The framework may take a set of unlabeled emails as input that are grouped based on URLs contained within the emails. The framework may return a set of spam URL signatures and a list of corresponding botnet host IP addresses by analyzing the URLs within the emails that are contained within the groups. Each URL signature may be in the form of either a complete URL string or a URL regular expression. The signatures may be used to identify spam emails launched from botnets, while the knowledge of botnet host identities can help filter other spam emails also sent by them.

### BACKGROUND

The term botnet refers to a group of compromised host computers (bots) that are controlled by a small number of commander hosts generally referred to as Command and Control (C&C) servers. Botnets have been widely used for sending large quantities of spam emails. By programming a large number of distributed bots, where each bot sends only a few emails, spammers can effectively transmit thousands of spam emails in a short duration. To date, detecting and blacklisting individual bots is difficult due to the transient nature of the attack and because each bot may send only a few spam emails. Furthermore, despite the increasing awareness of botnet infections and associated control processes, there is little understanding of the aggregated behavior of botnets from the perspective of email servers that have been targets of large scale botnet spamming attacks.

It has been observed that the spam uniform resource locator (URL) links within spam emails with identical URLs are highly clusterable and are often sent in a burst. This behavior is similar to worm propagation. However, signature generation for botnet spam presents challenges because HTML based emails often contain URLs generated by standard software in compliance with HTML standards, and spammers often intentionally add random and legitimate URLs to content in order to increase the perceived legitimacy of emails.

### SUMMARY

A framework may be used for generating URL signatures to identify botnet spam and membership. The framework may take a set of unlabeled emails as input and return a set of spam URL signatures and a list of corresponding botnet host internet protocol (IP) addresses. Each URL signature may be in the form of either a complete URL string or a URL regular expression. The signatures may be used to identify both present and future spam emails launched from botnets, while the knowledge of botnet host identities can help filter other spam emails also sent by them.

In some implementations, a system generates URL signatures to identify botnet spam and membership. The system may include a URL-preprocessor that extracts URLs from input emails and groups the emails into URL groups according to domains, a group selector that selects the URL groups in accordance with a predetermined feature, and a regular expression generator that determines a signature representative of URLs contained within the botnet spam. The signature may be used to determine spam emails sent by botnet hosts.

In some implementations, a method for generating URL signatures to identify botnet spam and membership includes extracting URLs from received emails, grouping the emails into groups according to a domain specified by extracted URLs, selecting the groups in accordance with a sending time burstiness or a distribution of an IP address space of the emails within the groups, and generating a signature representative of URLs contained within the botnet spam in accordance with the sending time burstiness or distribution of the IP address space to identify emails as being botnet spam.

In some implementations, a method for generating spam signatures to identify botnet spam and membership includes grouping emails into groups according to a domain specified by URLs within the emails, iteratively selecting the groups in accordance with a sending time burstiness or a distribution of an IP address space of the emails within the groups, and generating a URL based signature and a regular expression based signature for a set of URLs belonging to a same domain. Both complete URL based signatures and regular expression based signatures may be output to a spam filter.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific processes and instrumentalities disclosed. In the drawings:

FIG. 1 illustrates an exemplary botnet environment;

FIGS. 2 and 3 illustrate an exemplary framework for identifying botnet spam and membership;

FIG. 4 illustrates an exemplary process for generating spam signatures;

FIG. 5 illustrates an exemplary process for generating regular expressions;

FIG. 6 shows an exemplary signature tree;

FIG. 7 illustrates an example of generalization of URLs; and

FIG. 8 shows an exemplary computing environment.

### DETAILED DESCRIPTION

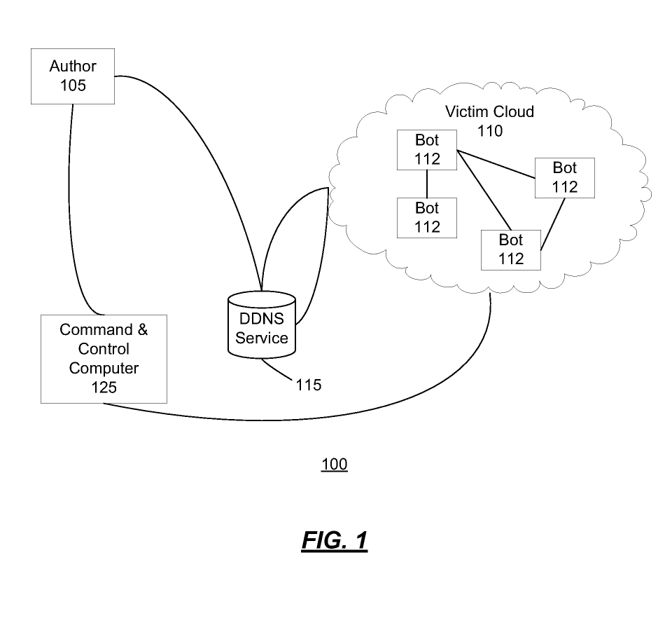

FIG. 1 illustrates an exemplary botnet environment 100 including botnets that may be utilized in an attack on an email server. FIG. 1 illustrates a malware author 105, a victim cloud 110 of bot computers 112, a Dynamic Domain Name System (DDNS) service 115, and a Command and Control (C&C) computer 125. Upon infection, each bot computer 112 contacts the C&C computer 125. The malware author 105 may use the C&C computer 125 to observe the connections and communicate back to the victim bot computers 112. More than one C&C computer 125 may be used, as a single abuse report can cause the C&C computer 125 to be quarantined or the account suspended. Thus, malware authors typically may use networks of computers to control their victim bot computers 112. Internet Relay Chat (IRC) networks are often utilized to control the victim bot computers 112, as they are very resilient. However, botnets have been migrating to private, non-IRC compliant services in an effort to avoid detection. In addition, malware authors 105 often try to keep their botnets mobile by using the DDNS service 115, which is a resolution service that facilitates frequent updates and changes in computer locations. Each time the botnet C&C computer 125 is shut down, the botnet author may create a new C&C computer 125 and update a DDNS entry. The bot computers 112 perform periodic DNS queries and migrate to the new C&C location. This practice is known as bot herding.

When botnets are utilized for an attack, the malware author 105 may obtain one or more domain names (e.g., example.com). The newly purchased domain names may be initially parked at 0.0.0.0 (reserved for unknown addresses). The malware author 105 may create a malicious program designed or modified to install a worm and/or virus onto a victim bot computer 112.

The C&C computer 125 may be, for example, a high-bandwidth compromised computer. The C&C computer 125 may be set up to run an IRC service to provide a medium for which the bots to communicate. Other services may be used, such as, but not limited to web services, on-line news group services, or VPNs. DNS resolution of the registered domain name may be done with the DDNS service 115. For example, the IP address provided for in the registration is for the C&C computer 125. As DNS propagates, more victim bot computers 112 join the network. The victim bot computer 112 contacts the C&C computer 125 and may be compelled to perform a variety of tasks, such as, for example, but not limited to updating their Trojans, attacking other computers, sending spam emails, or participating in a denial of service attack.

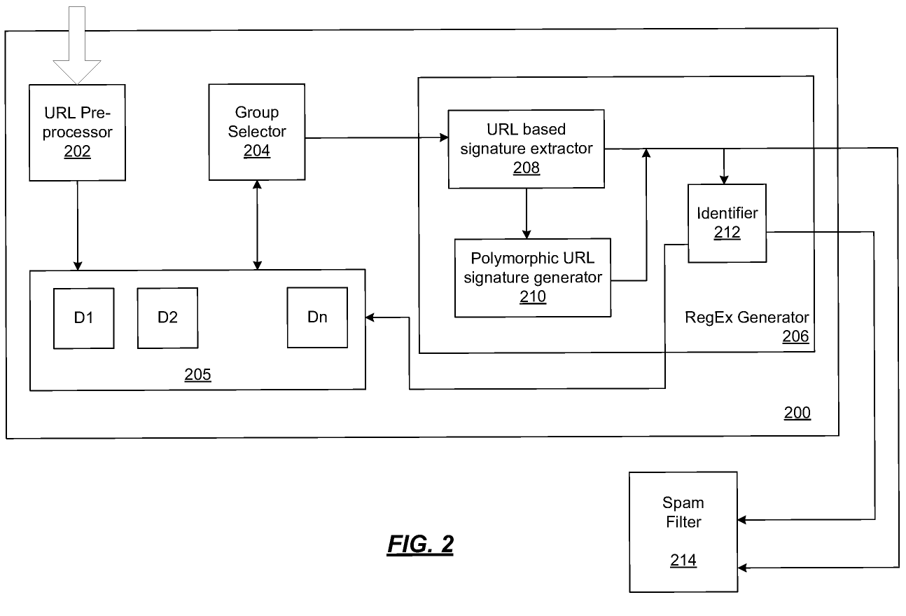

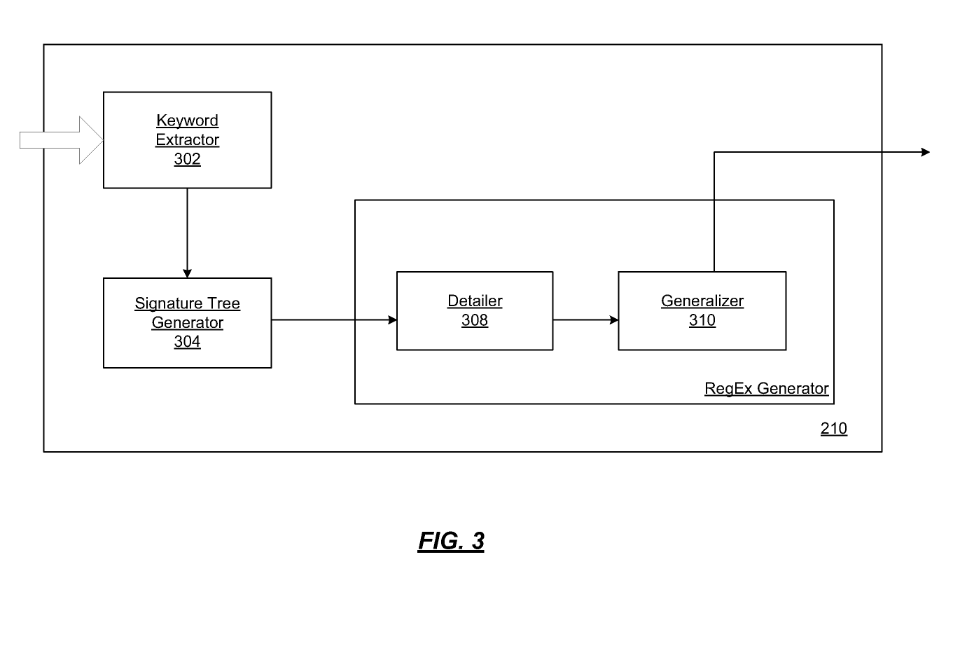

Referring to FIGS. 2 and 3, there is illustrated a framework 200 for automatically generating URL signatures for identifying botnet spam and membership. The framework 200 may take a set of unlabeled emails as input, and may output a set of spam URL signatures and a list of corresponding botnet host IP addresses. Each URL signature may be in the form of either a complete URL string or a URL regular expression. These signatures may be used to identify present and future spam emails launched from botnets, while the knowledge of botnet host identities may help filter other spam emails also sent by the botnet.

In some implementations, the framework 200 may not need knowledge regarding spam classification results, nor training data in order to generate signatures. The framework 200 operates by identifying the behavior exhibited by botnets, such as looking for spam email traffic that is bursty and distributed. The notion of “burstiness” means that emails from botnets are sent in a highly synchronized fashion as spammers typically rent them for a short period. The notion of “distributed” means that a botnet usually spans a large and well dispersed IP address space.

In some implementations, the framework 200 may employ an iterative algorithm or technique to identify botnet based spam emails that fit the above traffic profiles. It may generate regular expression signatures characterizing the underlying data, where the learned signatures attempt to encode maximal information about the matching URLs that characterize the spam emails sent from a botnet.

Referring to FIG. 2, the framework may include a URL preprocessor 202 that extracts URLs and other relevant fields from input emails and groups them according to domains. Each URL group may be treated as a candidate for identifying botnets and generating signatures. A group selector 204 may select a URL group with the highest level of sending time burstiness from the set of URL groups in 205 and may communicate the selected group to a regular expression (RegEx) generator 206. The RegEx generator 206 includes a URL based signature extractor 208 that extracts signatures by processing one group at a time and generates complete URL based signatures, described further with regard to FIGS. 3 and 5-7. Generally, a polymorphic URL signature generator 210 generates regular expression based signatures. An identifier 212 verifies the regular expressions to determine if the signatures meet certain criteria. Each time the RegEx generator 206 produces a signature, the matching emails and all their URLs may be discarded from further consideration in the remaining URL groups 205. This process may be iteratively repeated until all the groups are processed.

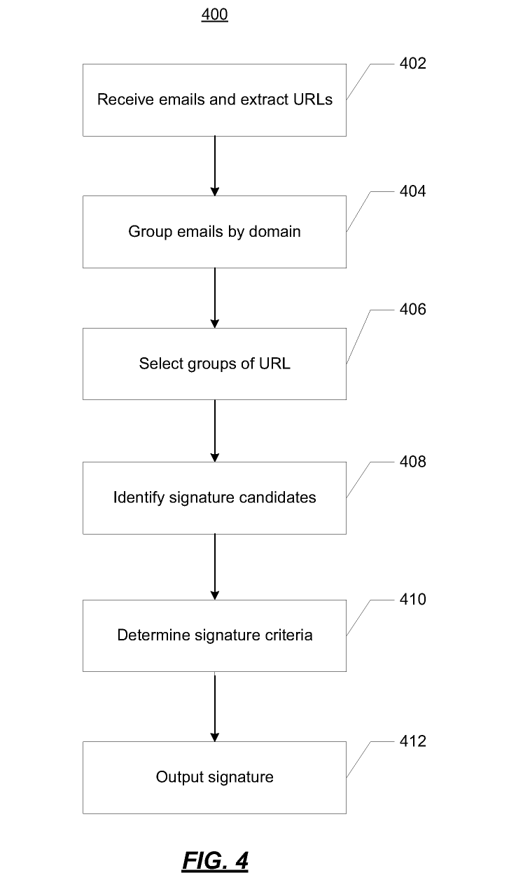

FIG. 4 illustrates an exemplary process 400 for generating spam signatures. At 402, emails are received and URLs within the emails are extracted. In some implementations, given a set of emails as input, URLs may be extracted by the URL pre-processor 202, where each URL is associated with a URL string, source server IP address, or email sending time. In addition, a unique email ID may be formed representing the email from which a URL was extracted. Forwarded emails may be discarded to avoid identifying a legitimate forwarding server as a botnet member.

At 404, the emails may be grouped. The group selector 204 may partition URLs into groups based on their domains. This partitioning may be performed because the same botnets usually advertise the same product or service from the same domain. In addition, by grouping URLs of the same domain together, the search scope for botnet signatures is significantly reduced. The generated domain-specific signatures may be further merged to produce domain-agnostic signatures. The URL group selection performed by the URL group selector 204 may associate each email with multiple groups if it contains multiple URLs from different domains. The URL group selector 204 may determine which group best characterizes an underlying botnet.

At 406, groups of URLs are selected. At every iteration, the URL group selector 204 may select a URL group that exhibits the strongest temporal correlation across a large set of distributed senders from the set of URL groups in 205. In an implementation, to quantify the degree of sending time correlation, for every URL group, the framework 200 may construct a discrete time signal S to represent the number of distinct source IP addresses that were active during a time window w. The value of the signal at the n-th window, denoted by Si(n), is defined as the total number of IP addresses that had sent at least one URL in group i in that window. Sharp signal spikes indicate a strong correlation, meaning a large number of IP addresses had all sent URLs targeting a common domain within a short duration. With this signal representation, the framework 200 may determine a global ranking of all the URL groups at each iteration by selecting signals with large spikes. In some implementations, a URL may be favored having the most narrow signal width each time (with tie breaking with the highest peak value).

For a set of URLs belonging to the same domain, the RegEx generator 206 may produce the following two types of signatures: complete URL based signatures and/or regular expression based signatures. Complete URL based signatures may be used to detect spam emails that contain an identical URL string. Regular expression based signatures may be used to detect spam emails that contain polymorphic URLs.

At 408, signature candidates may be identified. To produce complete URL based signatures, each URL string in the selected group (output at 406 by the RegEx generator 206) may be regarded as a signature candidate. To produce regular expression based signatures, URL regular expressions may be generated at 408 as candidates.

At 410, signature criteria are determined. The identifier 212 may further analyze the signature candidates to determine if the signature criteria of “distributed,” “bursty” and “specific” are met by the generated signature candidates.

The “distributed” property is quantified using the total number of Autonomous Systems (ASes) spanned by the source IP addresses. Counting the number of ASes rather than the number of IPs may be used because it is possible for a large company to own a set of mail servers with different IP addresses.

The “bursty” feature may be quantified by the duration of a particular email campaign launched by a botnet. In some implementations, a set of matching URLs should be sent in shorter than 5 days to qualify. However, a group of URLs may be retained even if their sending time is wide spread (greater than 5 days). The reason is that these URLs may correspond to different botnets, each of which is individually bursty. An iterative approach may separate these botnets and output different signatures.

The “specific” feature may be quantified using an information entropy metric pertaining to the probability of a random URL string matching the signature. In the complete URL case, each signature satisfies the “specific” property because it is a complete string and cannot be more specific.

At 412, a signature is output. When the framework 200 successfully derives a botnet signature (e.g., satisfying the three quality criteria), it outputs a spam signature to a spam filter 214. Correspondingly, the matching emails are identified as botnet based spam and the originating mail server IP addresses are output as botnet host IPs. If these spam emails contain URLs from multiple domains, the URLs may be removed from the remaining groups before the group selector 202 proceeds to select the next candidate group.

Using these features, generating complete URL based signatures may be accomplished by considering every distinct URL in the group to determine whether it satisfies the above quality criteria, and correspondingly removing the matching URLs from the current group. The remaining URLs may be further processed to generate regular expression based signatures.

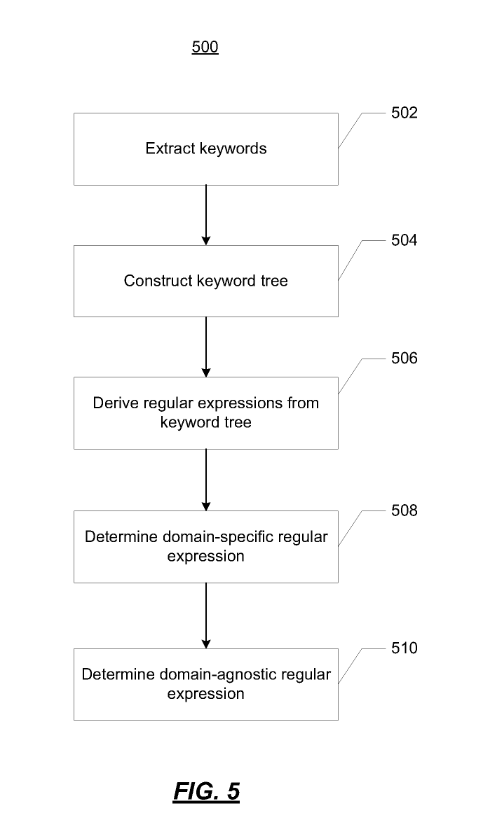

FIG. 5 illustrates an exemplary process 500 for generating regular expressions within the polymorphic URL signature generator 210 of FIG. 3. The input to the polymorphic URL signature generator 210 may be a set of polymorphic URLs from a same domain. The regular expression signature generation process involves constructing a keyword based signature tree, generating regular expressions, and evaluating the quality of the generated signatures to determine if they are specific enough with low false positive rates.

At 502, keywords are extracted. A keyword extractor 302 may extract frequent substrings, from which a set may serve as a base for regular expression generation. A suffix array algorithm may be used to efficiently derive possible substrings and their frequencies. To derive a keyword that is not too general, substrings of length at least two may be considered. To determine the combinations of frequent substrings that constitute a signature, some implementations may start with a most frequent substring that is both bursty and distributed. More substrings may be incrementally added to obtain a more specific signature.

At 504, a keyword tree is constructed. A signature tree generator 304 may construct a keyword based signature tree where each node corresponds to a substring, with the root of the tree being the domain name. The set of substrings on the path from the root to a leaf node defines a keyword based signature, each associated with one botnet. Initially, there is only the root node which corresponds to the domain string and all the URLs in the group are associated to it. Given a parent node, the framework looks for the most frequent substring. If combining this substring with the set of substrings along the path from the root satisfies the preset AS and sending time constraints, the framework creates a new child node. Consequently the matching URLs will be associated to this new node. For the remaining URLs and popular substrings, the same process may be repeated for the same parent node until there is no such substring to continue. Next, the process may move on to each child node and be repeated.

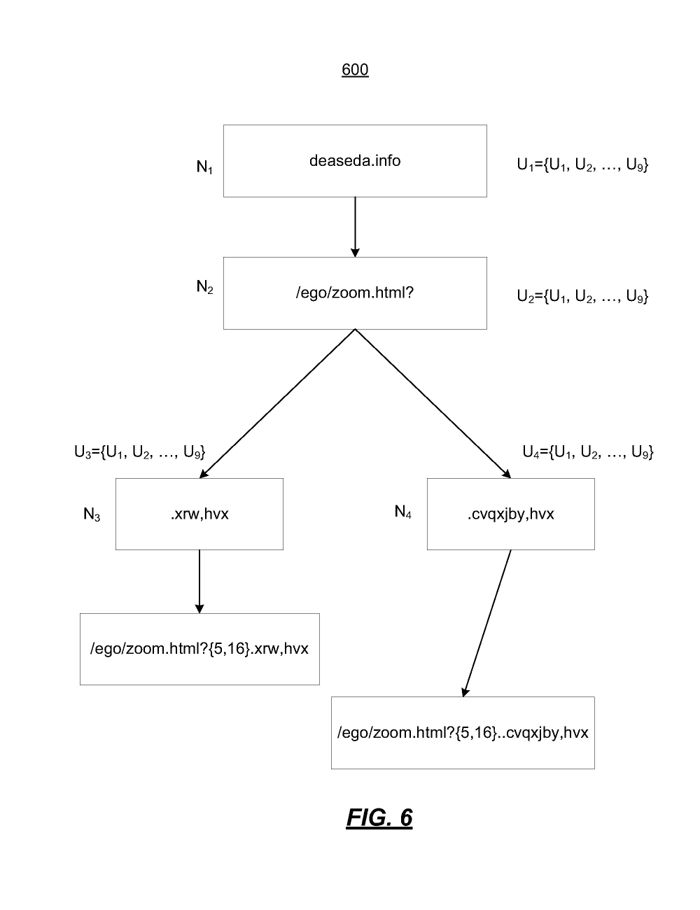

FIG. 6 shows an exemplary signature tree. The exemplary signature tree is constructed from a set of nine URLs, from domain deaseda.info. The URLs may be as follows:

u₁: http://deaseda.info/ego/zoom.html?QjQRP_xbZf.cVQXjbY,hVX

u₂: http://deaseda info/ego/zoom html?giAfS.cVQXjbY,hVX

u₃: http://deaseda.info/ego/zoom.html?RQbWfeVY2fWifSd.cVQXjbY,hVX

u₄: http://deaseda.info/ego/zoom.html?UbSjWcjHC.cVQXjbY,hVX

u₅: http://deaseda.info/ego/zoom.html?VPS_eYVNfs.cVQXjbY,hVX

u₆: http://deaseda.info/ego/zoom.html?QNVRcjgVNSbgfSR.XRW,hVX

u₇: http://deaseda info/ego/zoom html?afRZXQ.XRW,hVX

u₈: http://deaseda info/ego/zoom html?YcGGA.XRW,hVX

u₉: http://deaseda.info/ego/zoom.html?aeSfLWVYgRIBH.XRW,hVX

As shown, there are two signatures corresponding to nodes N₃ and N₄, each defining a botnet. A tree may be used to generate multiple signatures either because the signatures correspond to different botnets, or because each signature occurs with enough significance in the received emails to be recognized as different even though the different signatures map to one botnet.

At 506, the regular expressions are derived from the keyword tree. This may include operations of detailing and generalization. At 508, domain-specific regular expressions are determined by the detailing process. A detailer 308 may return a domain-specific regular expression using a keyword based signature as input. This provides information regarding the locations of the keywords, the string length, and the string character ranges. The detailing process leverages the derived frequent keywords as fixed anchor points, and then applies a set of predefined rules to generate regular expressions for the substring segments between anchor points. The final regular expression is the concatenation of the set of fixed anchoring keywords and segment based regular expressions. Each regular expression for a substring segment may have the format C{l₁, l₂} where C is the character set, and l₁ and l₂ are the minimum and maximum substring lengths. Without loss of generality, frequently used character sets may be used: [0-9], [a-zA-Z] and special characters (e.g., ‘.’, ‘@’) according to the URL standard. The lengths are derived using the input URLs. After this step, each regular expression is domain-specific. FIG. 6 shows such examples derived from the keyword based signatures.

At 510, domain-agnostic regular expressions are determined by the generalizing process. A generalizer 310 may return a more general domain-agnostic regular expression by further merging very similar domain-specific regular expressions. This may increase the coverage of botnet spam detection. The generalization process takes domain-specific regular expressions and further groups them as spammers that sign up many domains. For example, one IP address can host more than 100 domains. If one domain gets blacklisted, spammers can quickly switch to another. Although domains are different, the URL structures of these domains are similar. Therefore, if two regular expressions differ only in the domain and substring lengths, they can be merged by discarding domains, and taking the lower bound (upper bound) as the new minimum (maximum) substring length.

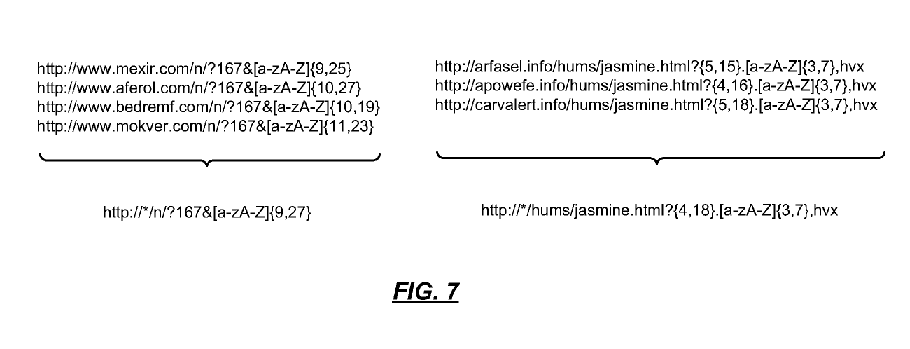

FIG. 7 illustrates an example of generalization. In FIG. 7, the example preserves the keyword /n/?167& and the character set [a-zA-Z], but discards domains and adjusts the substring segment lengths to {9,27}.

In some implementations, the generalization process may generate over-generalized signatures. The identifier 212 may quantitatively measure the quality of a signature and discard signatures that are too general. A metric (entropy reduction) may quantify the probability of a random string matching the signature. Given a regular expression e, its entropy reduction d(e) is computed as the difference between the expected number of bits used to encode a random string u with and without the signature, denoted as Be(u) and B(u), respectively, i.e., d(e)=B(u)−Be(u). The entropy reduction d(e) reflects the probability of an arbitrary string with expected length allowed by e and matching e, but not encoded using e. This probability may be written as

$$P ( e ) = \frac{{2}^{{B}_{e} ( u )}}{{2}^{B ( u )}} = \frac{1}{{2}^{B ( u ) - {B}_{e} ( u )}} = \frac{1}{{2}^{d ( e )}}$$

Given a regular expression e, its entropy reduction d(e) depends on the cardinality of its character set and the expected string length. Intuitively, a more specific signature e requires fewer bits to encode a matching string, and therefore d(e) tends to be larger. The framework discards signatures whose entropy reductions are smaller than a preset threshold, e.g., 90, which viewed another way means the probability of a random string matching the signature is 1/2⁹⁰. Thus, based on the metric, a signature AB[1-8]{1,1} is much more specific than [A-Z0-9]{3,3} even though they are of the same length.

Exemplary Computing Arrangement

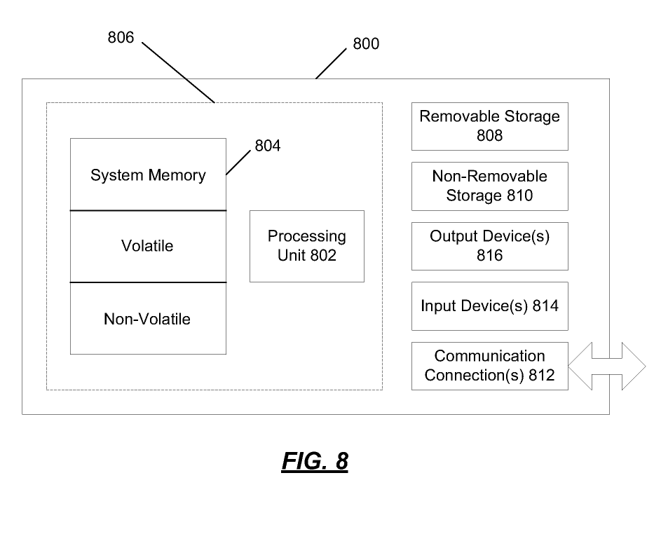

FIG. 8 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that performs particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as RAM), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by device 800 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communications connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for generating uniform resource locator (URL) signatures to identify botnet spam and membership, comprising:
a URL preprocessor that extracts a plurality of URLs from a plurality of input emails and groups the input emails into a plurality of URL groups according to their corresponding domains;
a group selector that selects the URL groups in accordance with a predetermined feature; and
a regular expression generator that determines a signature representative of the URLs contained within a botnet spam.

2. The system of claim 1, wherein the predetermined feature is one of a sending time burstiness, a distribution of an internet protocol (IP) address space, or a specificity of the signature.

3. The system of claim 2, wherein for each URL, the group selector selects a group of URLs that exhibit the strongest temporal correlation across a set of distributed senders.

4. The system of claim 3, wherein a discrete time signal, reflecting a number of distinct source IP addresses that were active during a time window, is determined to represent the temporal correlation among distributed senders.

5. The system of claim 2, wherein for each determined signature, an entropy reduction based metric is used to quantify a specificity of the signature.

6. The system of claim 2, wherein the distribution is quantified using the total number of autonomous systems spanned by source IP addresses within the IP address space.

7. The system of claim 1, wherein the group selector associates an email with multiple groups if the email contains multiple URLs from different domains.

8. The system of claim 1, wherein the signature comprises one of a complete URL based signature or a regular expression based signature for a set of URLs belonging to a same domain.

9. The system of claim 8, wherein emails that match the complete URL based signature or regular expression based signature are identified as botnet sent spam emails.

10. The system of claim 9, wherein IP addresses corresponding to senders of the botnet sent spam emails are identified, and wherein each signature distinguishes a unique group of botnet hosts under the control of a common command and control computer.

11. The system of claim 10, wherein the complete URL based signature or regular expression based signature and the IP addresses are used to filter future spam emails.

12. A computer-implemented method for generating uniform resource locator (URL) signatures to identify botnet spam and membership, comprising:
extracting a plurality of URLs from a plurality of received emails;
grouping the emails into a plurality of groups according to a domain specified by the extracted URLs;
selecting the groups in accordance with a sending time burstiness or a distribution of an internet protocol (IP) address space of the emails within the groups; and
generating a signature representative of URLs contained within a botnet spam in accordance with the sending time burstiness or distribution of the IP address space to identify emails as being botnet spam.

13. The computer-implemented method of claim 12, further comprising:
selecting a group that exhibits a strongest temporal correlation across a set of distributed senders;
determining a signal spike within the group indicative of a number of IP addresses sending URLs targeting a common domain within a predetermined duration; and
ranking the group based on the signal spike.

14. The computer-implemented method of claim 12, further comprising:
quantifying the distribution using a total number of autonomous systems spanned by source IP addresses within the IP address space.

15. The computer-implemented method of claim 12, further comprising:
generating complete URL based signatures or regular expression based signatures for a set of URLs belonging to a same domain.

16. The computer-implemented method of claim 15, further comprising:
applying the complete URL based signature to detect spam emails that contain an identical URL string to the complete URL based signature; and
applying the regular expression based signatures to detect spam emails that contain polymorphic URLs.

17. The computer-implemented method of claim 15, further comprising:
receiving a set of polymorphic URLs from a same domain; and
constructing a keyword based signature tree to generate the regular expression based signatures.

18. A computer-implemented method for generating a spam signature to identify botnet spam and membership, comprising:
grouping a plurality of emails into a plurality of groups according to a domain specified by a plurality of uniform resource locators (URLs) within the emails;
iteratively selecting the groups in accordance with a sending time burstiness or a distribution of an internet protocol (IP) address space of the emails within the groups;
generating URL based signatures or regular expression based signatures for a set of URLs belonging to a same domain; and
outputting the URL based signature and a regular expression based signature to a spam filter.

19. The computer-implemented method of claim 18, further comprising:
applying the URL based signature to detect spam emails that contain an identical URL string to the complete URL based signature; and
applying the regular expression based signatures to detect spam emails that contain polymorphic URLs.

20. The computer-implemented method of claim 18, further comprising:
generating regular expressions from different domains and similar structures into a domain-agnostic regular expression; and
applying the regular expressions to capture spam emails that include URLs having different domains and a same URL structure.
